(19) United States
(12) Patent Application Publication
(10) Pub. No.: US 2018/0231187 A1
(43) Pub. Date: Aug. 16, 2018

(54) PROTECTIVE CAP, BOTTLE INCLUDING SUCH A CAP, AND METHOD FOR MOUNTING OR REMOVING SAID CAP

(71) Applicant: L'Air Liquide, Société Anonyme pour I'Etude et I'Exploitation des Procédés Georges Claude, Paris (FR)

(72) Inventors: Antoine FRENAL, Paris (FR); Renaud LIGONESCHE, Houston, TX (US)

(21) Appl. No.: 15/749,201

(22) PCT Filed: Jul. 20, 2016
(86) PCT No.: PCT/FR2016/051874

§ 371 Date: Jan. 31, 2018

(30) Foreign Application Priority Data
Jul. 31, 2015 (FR) 1557424

(51) Int. Cl. F17C 13/06; F17C 1/00

(52) U.S. Cl. CPC F17C 13/06; F17C 1/00; F17C 2201/0104; F17C 2270/0745; F17C 2205/0308; F17C 2260/015; F17C 2201/032

(57) ABSTRACT

A pressurized fluid cylinder valve protection cap including a rigid structure delimiting a protection volume for a valve, the rigid structure including a lower end configured to be fixed to the upper end of a pressurized fluid cylinder, the lower end including a mounting collar provided on its internal surface with attachment imprints, designed to cooperate attachment fashion with a system of conjugate imprints, of the upper end of a pressurized fluid cylinder.

### CROSS REFERENCE TO RELATED APPLICATIONS

This application is a 371 of International Patent Application PCT/FR2016/051874, filed Jul. 20, 2016, which claims priority to French Patent Application 1557424, filed Jul. 31, 2015, the entire contents of which are incorporated herein by reference.

### BACKGROUND

The invention concerns a pressurized fluid cylinder valve protective cap, a cylinder including such a cap and its mounting or demounting method.

The invention more particularly concerns a pressurized fluid cylinder valve protection cap comprising a rigid structure delimiting a protection volume for a valve, this structure comprising a lower end intended to be fixed to the upper end of a pressurized fluid cylinder, said lower end comprising a mounting collar provided on its internal surface with attachment imprints, notably an internal screwthread, intended to cooperate attachment fashion with a system of conjugate imprints, notably an external screwthread, at the upper end of a pressurized fluid cylinder, the collar being composed of at least two portions adapted to be moved or deformed one relative to the other to increase or to reduce the diameter of said collar in order to facilitate its mounting and/or demounting, the cap further comprising a device for tightening the collar to reduce its diameter comprising a system of the type with a bolt and a nut, the two portions of the collar each comprising a respective housing for a system comprising a bolt and a nut, the two housings being disposed adjacently, a first housing being adapted to receive: a first end of a head of the bolt of the nut and bolt system, the second housing being adapted to receive the second end of the bolt and a nut cooperating with the bolt, each housing comprising respective walls forming a system of abutments respectively for the head of the bolt and the nut to transmit a tightening force.

When a protective cap is mounted on or demounted from a cylinder, those tasks can necessitate a certain number of operations and/or tools.

In particular, when the cap is screwed onto or similarly mounted on an end (neck) of the cylinder, the system for attachment to the cylinder (the external screwthread in the case of a screw system) can be damaged. It is therefore necessary to provide on the cap a deformable system facilitating mounting or demounting the cap.

The known solutions consist in providing a cap the structure of which includes a plurality of parts (for example two half-shells) and possibly an intermediate split ring, a loosening tool, etc.

These solutions are relatively complex, however, and necessitate separate parts or tools.

### SUMMARY

An object of the present invention is to alleviate some or all of the disadvantages of the prior art referred to above.

To this end, the cap according to the invention, otherwise conforming to the generic definition thereof given in the above preamble, is essentially characterized in that each housing comprises respective walls forming a system of abutments respectively for the head of the bolt and the nut also to transmit a force for moving the two portions of the collar away from each other when unscrewing the nut relative to the bolt.

Moreover, embodiments of the invention can include one or more of the following features:
the nut is a part separate from the cap screwed onto said bolt,
the nut is a part formed by an internally threaded portion of the cap screwed onto said bolt,
the collar comprises a structure of annular shape comprising a split forming a gap enabling two adjacent ends of the collar delimiting the gap to be moved away from each other or toward each other, the two housings for the nut/bolt system being respectively situated at the level of the two ends of the collar delimiting the gap,
the nut is prevented from rotating in its housing about the longitudinal axis of the bolt,
the head of the bolt is free to rotate in its housing about the longitudinal axis of the bolt,
the cap comprises an access orifice to the housing of the bolt to allow relative screwing or unscrewing of the bolt/nut system inside the housings,
in the mounted position, the nut and/or the head of the bolt include(s) faces perpendicular to the longitudinal axis of the bolt, the walls of the housings forming a system of abutments respectively for the bolt head and the nut being perpendicular to the longitudinal axis of the bolt,
at least one of the following: the nut, the head of the bolt has a clearance in its housing in a direction parallel to the longitudinal axis of the bolt,
the nut and/or the bolt and notably the head of the bolt are housed in a stable manner in their housing, notably by means of a force-fit.

The invention also concerns a pressurized fluid cylinder comprising a valve and a protection cap for the valve, the cap being mounted around a neck of cylindrical shape, the cap having any one of the above or following features.

The invention also concerns a method of mounting or demounting a cap having any one of the above features on or from a pressurized fluid cylinder, the method comprising a step of screwing and/or unscrewing the bolt/nut system to move toward each other or away from each other the two portions of the mounting collar of the cap and respectively generating a force for moving toward each other or away from each other said portions via the nut and/or the head of the bolt of the bolt/nut system upon the movement toward each other or away from each other of the nut relative to the bolt head.

The invention can also concern any alternative device or method having any combination of the above or following features.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a diagrammatic partial side view showing a pressurized fluid cylinder provided with a valve and a cap to protect the valve,

FIG. 2 is a diagrammatic partial perspective view showing the upper end of a cylinder and the lower end of a cap in a demounted position,

FIG. 3 is a view analogous to that of FIG. 2 in an assembled position,

FIG. 4 is a diagrammatic partial bottom view of a detail of the cap from FIGS. 2 and 3 showing a cap tightening device in the demounted position,

FIGS. 5 and 6 are diagrammatic partial bottom views of a detail of the cap from FIGS. 2 and 3 showing the tightening device from FIG. 4 in the mounted position and respectively in a configuration loosening the cap and a configuration tightening the cap,

FIG. 7 is a diagrammatic partial bottom view of a detail of the cap from FIGS. 2 and 3 showing a variant embodiment of a device for tightening the cap in the mounted position.

### DESCRIPTION OF PREFERRED EMBODIMENTS

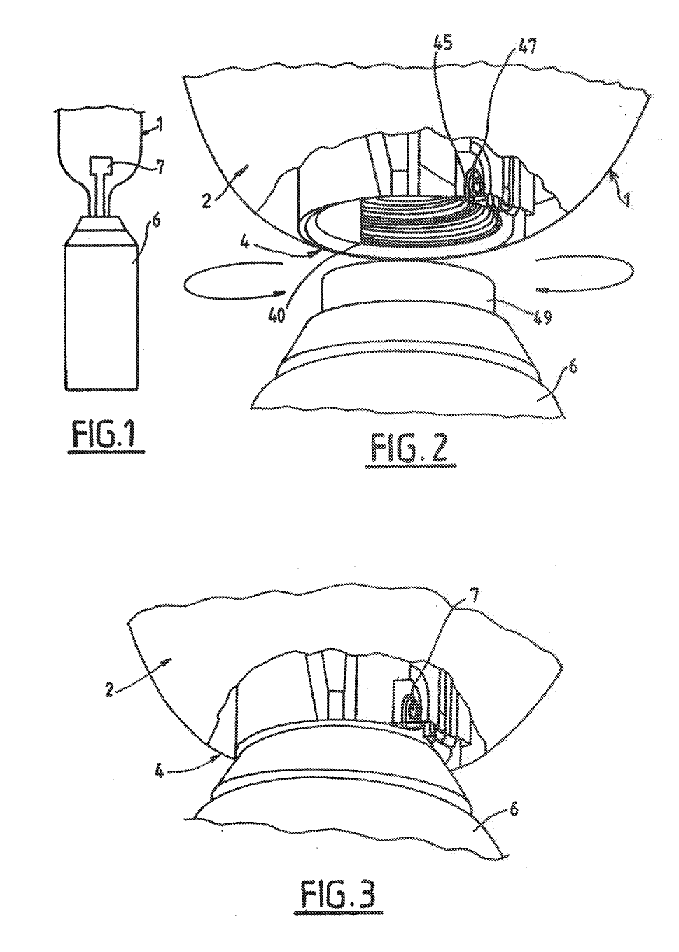

A cap 1 for protecting a valve 7 of a pressurized fluid cylinder 6 conventionally comprises a rigid structure 2 delimiting a protection volume for a valve 7 (cf. FIG. 1).

This rigid structure 2, for example in the form of a cage, arch or tube, includes a lower end intended to be fixed to the upper end of a pressurized fluid cylinder.

This lower end can comprise in particular a mounting collar 4 adapted to be fixed to the (for example cylindrical) neck at the upper end of a cylinder 6. This collar 4 can be fixed directly to the cylinder 6 or to an intermediate part disposed between the cap 1 and the cylinder 6.

At least part of the internal surface of the collar 4 is conventionally provided with attachment imprints 40 intended to cooperate attachment fashion with a system 49 of conjugate imprints on the upper end of the cylinder 6.

The imprint system can include ribs and recesses to immobilize the cap 1 in vertical translation on the cylinder 6 and preferably also to prevent it from rotating about the longitudinal axis of the cylinder 6.

One conventional attachment system employs screwing. In other words the collar 4 of the cap 1 has an internal screwthread and is screwed onto an external screwthread on the cylinder 6.

In the nonlimiting example from the figures, the collar 4 is composed of two portions 41, 42 adapted to be moved one relative to the other, for example by elastic deformation, to increase or to reduce the diameter of said collar 4 in order to facilitate demounting it and/or mounting it.

The cap 1 comprises a device for tightening or loosening the collar 4 or loosening to reduce or to increase its diameter.

This device comprises a system of the type with a bolt 47 and a nut 48.

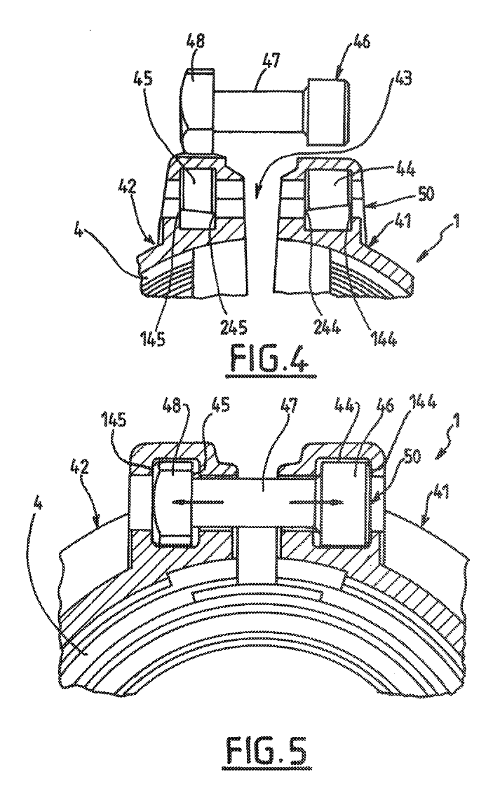

As can be seen in FIG. 4, the two portions 41, 42 of the collar 4 each comprise a respective housing 44, 45 adjacent the gap (i.e. adjacent the split in the collar 4).

A first housing 44 is adapted to receive: a first end of a head 46 of the bolt 47. The second housing 45 is adapted to receive the nut 48 and the end of the bolt on which it is mounted.

The device with the bolt 47 and the nut 48 forms a system for adjusting the diameter or the shape of the collar 4 by controlling the size of the gap 43.

Each housing 44, 45 comprises respective walls 144, 244, 145, 245 forming a system of abutments respectively for the bolt head 46 and the nut 48. Thus, to facilitate mounting the cap 1 on the cylinder 6, the bolt-nut system is unscrewed until the nut 48 and the bolt head bear on the corresponding walls of the housings. Further torque is applied to move the two faces away from each other, enabling enlargement of the diameter of the internal screwthread.

In other words, during the relative movement away from each other of the nut 48 and the bolt head 46 end faces thereof generate a force on the end walls 144, 145 of the housings 44, 45. This enables the two portions 41, 42 of the collar 4 to be moved away from each other (cf. FIG. 5 where the unscrewing that causes the movement away from each other is symbolized by two diverging arrows).

The cap 1 can then be screwed more easily onto the cylinder 6 by screwing using the external thread/internal thread system (or some other equivalent system). As soon as the mounted position of the cap 1 of the cylinder is satisfactory, the cap 1 can be retained in position by tightening the bolt/nut assembly.

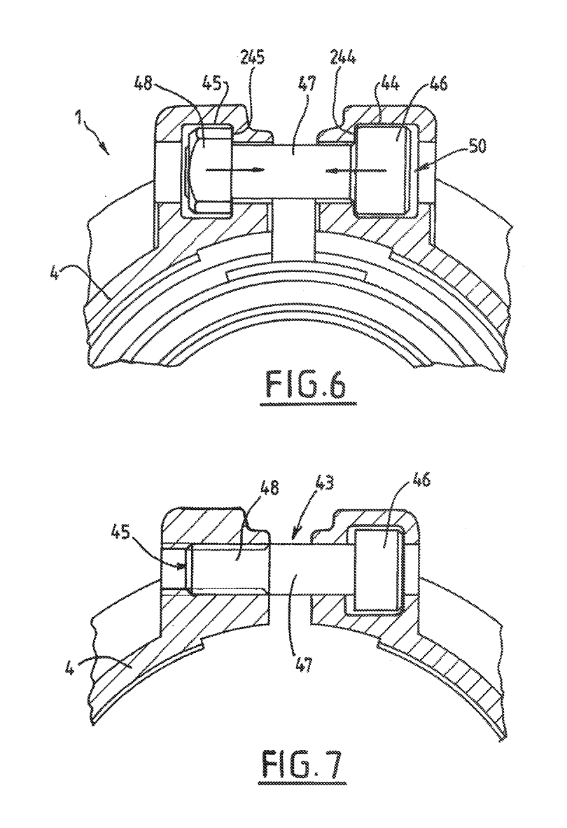

Upon relative movement toward each other of the nut 48 and the bolt head 46, interior faces thereof (i.e. the faces adjacent the gap 43) generate a force on the internal walls 244, 245 of the housings 44, 45. This allows movement toward each other of the two portions 41, 42 of the collar 4 and where applicable closing of the gap 43 (cf. FIG. 6 where the screwing that causes the movement toward each other is symbolized by two converging arrows).

To lock the cap 1 in position, the bolt 47 can be tightened until the bolt head 46 bears on the internal wall 244 of the housing 44. Further tightening torque can be applied to move the two parts 41, 42 toward each other enabling locking of the threads of the cap 1 against rotation on the threads of the cylinder 6.

Demounting can be performed by the reverse process. The bolt/nut device can be loosened so as to bear on the end walls 144, 145 of the housings 44, 45 (i.e. on the walls 144, 145 of the housings opposite the internal walls 244, 245). Further torque can then be applied to move the two faces away from each other, enabling enlargement of the diameter of the internal screwthread. The cap 1 can then be unscrewed from the cylinder 6 more easily.

Thus, the same system with the bolt 47 and the nut 48 can be used in both the phases of mounting and demounting the cap 1 on/from the cylinder 6 (to loosen or to tighten the collar 4 of the cap 1).

Separate walls preferably form abutments for tightening and loosening, respectively. Loosening enables the gap 43 to be enlarged beyond its “normal” size (the normal size refers to the size of the gap 43 when the collar is at rest, i.e. not subject to any tightening or loosening force).

For example, the end wall(s) 144 and in particular the end wall cooperating with the head 46 of the bolt form(s) an abutment enabling the bolt/nut system to move the two portions away from each other.

The nut 48 and the head 46 of the bolt include for example faces perpendicular to the longitudinal axis of the bolt 47. The walls 144, 244, 145, 245 of the housings 44, 45 form a system of abutments respectively for the bolt head 46 and the nut 48 that are also perpendicular to the longitudinal axis of the bolt 47.

The nut 48 is preferably prevented from rotating in its housing 45 about the longitudinal axis of the volt 47 (for example the nut 48 is square is received in a complementary housing that prevents it rotating about the longitudinal axis of the bolt 47). One possible alternative is for the nut to be able to turn in its housing and in this case it is prevented from rotating by a tool (wrench screwdriver) manipulated by an operator.

The head 46 of the bolt 47 is free to rotate in its housing 44 about the longitudinal axis of the bolt 47. The cap 1 includes an access orifice 50 or passage to the internal volume of the housing 44 that accommodates the bolt head 46 to allow the passage of a tool (a bolt or wrench etc.) and to allow the rotation of the head 46 of the bolt 47.

Without this being limiting, the assembly bolt 47 can be of the socket-head type for example.

The nut can have a hexagonal or triangular shape or any other appropriate shape.

The head 46 of the bolt 47 preferably has a clearance in its housing 44, 45 in a direction parallel to the longitudinal axis of the bolt 47.

The nut 48 and/or the bolt 47 and in particular the head 46 of the bolt are preferably housed in a stable manner in their housing 44, 45, notably by means of a force-fit. In other words the tightening/loosening system is fastened to the collar 4 or the cap 1. The operator does not have to manipulate separate parts and there is less risk of losing them. For example, the cap 1 has a specific imprint including or more zones allowing the insertion and the retention of the bolt 47 and the nut 48. Solutions other than a force-fit can be adopted (gluing, welding, etc.).

As shown in FIG. 7, the nut 48 separate from the cap can be replaced by an internal screwthread formed in a portion of the cap forming an internally threaded housing 45 intended to receive the end of the bolt 47. In other words the bolt 47 is screwed directly into an internally threaded portion of the cap or a part fastened to the cap. In this case the tightening/loosening force is transmitted directly to the cap (collar 4) via the threads of the internal screwthread. In other words the internally threaded portion forms a nut that cooperates with the bolt 47.

The variant from FIGS. 4 to 6 with a nut makes it possible to avoid machining to rework the cap.

For improved control of the deformation of the collar 4, the cap 1 can include a second bolt/nut tightening/loosening device as described above or of another known type. For example, this second tightening/loosening system is diametrically opposite the first tightening/loosening device at the level of the collar.

This tightening/loosening system can be applied in particular to a cap structure utilizing an intermediate mounting split ring forming an entity structurally separate from the cap (cf. for example FR2900717A1).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1.-12. (canceled)

13. A pressurized fluid cylinder valve protection cap comprising;
a rigid structure delimiting a protection volume for a valve, the rigid structure comprising a lower end configured to be fixed to the upper end of a pressurized fluid cylinder, the lower end comprising a mounting collar provided on its internal surface with attachment imprints, configured to cooperate attachment fashion with a system of conjugate imprints, of the upper end of a pressurized fluid cylinder, the collar being composed of at least two portions configured to be moved or deformed one relative to the other to increase or to reduce the diameter of the collar in order to facilitate mounting and/or demounting, the cap further comprising a device for tightening the collar to reduce its diameter comprising a system of the type with a bolt and a nut, the two portions of the collar each comprising a respective housing for a system comprising a bolt and a nut, the two housings being disposed adjacently, a first housing being configured to receive: a first end of a head of the bolt of the nut and bolt system, the second housing being adapted to receive the second end of the bolt and a nut cooperating with the bolt, each housing comprising respective walls forming a system of abutments respectively for the head of the bolt and the nut to transmit a tightening force, wherein each housing comprises respective walls forming a system of abutments respectively for the head of the bolt and the nut also to transmit a force for moving the two portions of the collar away from each other when unscrewing the nut relative to the bolt.

14. The cap as claimed in claim 13, wherein the nut is a part separate from the cap screwed onto the bolt.

15. The cap as claimed in claim 13, wherein the nut is a part formed by an internally threaded portion of the cap screwed onto the bolt.

16. The cap as claimed in claim 13, wherein the collar comprises a structure of annular shape comprising a split forming a gap enabling two adjacent ends of the collar delimiting the gap to be moved away from each other or toward each other and wherein the two housings for the nut/bolt system are respectively situated at the level of the two ends of the collar delimiting the gap.

17. The cap as claimed in claim 13, wherein the nut is prevented from rotating in the housing about the longitudinal axis of the bolt.

18. The cap as claimed in claim 13, wherein the head of the bolt is free to rotate in the housing about the longitudinal axis of the bolt.

19. The cap as claimed in claim 13, wherein the cap comprises an access orifice to the housing of the bolt to allow relative screwing or unscrewing of the bolt/nut system inside the housings.

20. The cap as claimed in claim 13, wherein in the mounted position, the nut and/or the head of the bolt include(s) faces perpendicular to the longitudinal axis of the bolt and wherein the walls of the housings forming a system of abutments respectively for the bolt head and the nut are perpendicular to the longitudinal axis of the bolt.

21. The cap as claimed in claim 13, wherein at least one of the following: the nut, the head of the bolt has a clearance in the housing in a direction parallel to the longitudinal axis of the bolt.

22. The cap as claimed in claim 13, wherein the nut and/or the bolt are housed in a stable manner in their housing.

23. A pressurized fluid cylinder comprising a valve and a protection cap for the valve, the cap being mounted around a neck of cylindrical shape, and in which the cap conforms to claim 13.

24. A method of mounting or demounting a cap conforming to claim 13 on or from a pressurized fluid cylinder, further comprising a step of screwing and/or unscrewing the bolt/nut system to move toward each other or away from each other the two portions of the mounting collar of the cap and respectively generating a force for moving toward each other or away from each other the portions via the nut and/or the head of the bolt of the bolt/nut system upon the movement toward each other or away from each other of the nut relative to the bolt head.
